(19) United States
(12) Patent Application Publication
(10) Pub. No.: US 2016/0098742 A1
(43) Pub. Date: Apr. 7, 2016

(54) Geofencing system for obtaining personal location and preference data and automatic distribution of consumer specific data, benefits and incentives based on variable factor matrix determinations

(71) Applicants: Alex Minicucci, San Luis Obispo, CA (US); Luke A. Wallace, San Luis Obispo, CA (US)

(72) Inventors: Alex Minicucci, San Luis Obispo, CA (US); Luke A. Wallace, San Luis Obispo, CA (US)

(21) Appl. No.: 14/121,684

(22) Filed: Oct. 7, 2014

(51) Int. Cl. G06Q 30/02

(52) U.S. Cl. CPC G06Q 30/0226; G06Q 30/0237

(57) ABSTRACT

A geo-fencing marketing system and method for the acquisition of personal data via location specific data entry and associated non-transitory computer-readable storage media having computer-executable instructions embodied thereon situated within a business environment to secure customer data for use in SMS/text location specific marketing campaigns and to permit automation of personalized marketing, benefits and incentives to customers as a function of specific customer preference data, historical activities and variable factor matrix determinations. The system and method further provide auto-feedback updating to modify the variable factor matrix.

### FIELD OF THE INVENTION

The present invention relates to the field of personalized consumer marketing and more specifically a geo-fencing marketing system and method for the acquisition of personal data via location specific data entry and associated non-transitory computer-readable storage media having computer-executable instructions embodied thereon situated within a business environment to secure customer data for use in SMS/text location specific marketing campaigns and to permit automation of personalized marketing, benefits and incentives to customers as a function of specific customer preference data, historical activities and variable factor matrix determinations. The system and method further provide auto-feedback updating to modify the variable factor matrix and data/status updates of the market campaign based on business designated triggers.

The present invention further relates to the cross referencing of consumer loyalty related incentives among proximately related merchants based upon personalized consumer preferences, location based determinants and matrix complement factors to automatically deliver to a consumer a personalized offer, incentive, benefit or data relating thereto in order to solicit the consumer's immediate participation in the offer, incentive or benefit by visiting the designated location of a proximately related merchant.

The present invention further relates to the field of interactive marketing and data acquisition and transmittal to permit such marketing to be based upon, but not limited to, a personalized, geocentric marketing system using short message services (SMS) provided on mobile devices such as cell phones or other telecommunication systems permitting SMS or other short code transmissions.

The present invention further relates to the use of location specific data and affirmative loyalty action by a consumer at one location to generate a personalized, geocentric marketing incentives using SMS provided on a mobile device such as cell phones or other telecommunication systems permitting SMS or other short code transmissions to deliver to the consumer a geo-fence based personalized offer, incentive, benefit or data relating thereto in order to solicit the consumer's immediate visitation of the designated location of a proximately related merchant to participate in the offer.

The present invention relates to the field of marketing and the acquisition of personal data via a loyalty kiosk situated within a business environment to provide instantaneous geo-positioning information on a user without requiring the user to either have a geo-positioning application on their mobile device or take action on their mobile device to identify where they are.

The present invention relates to the field of marketing and the acquisition of phone numbers and customer data for use in SMS/text marketing campaigns and related data mining to permit automation of personalized marketing to customers as a function of input data and historical activities. The system and method further provide, cross-marketing campaigns through loyalty kiosk data/status inputs, variable factor matrix determinations and marketing campaign based on business designated triggers.

The present invention further relates to improved methods and systems for utilizing the geocentric information obtained from customers at the time they log into a loyalty kiosk to create loyalty marketing opportunities for proximately related merchants, generate concomitant sales and more particularly to permit targeted marketing campaigns based on location and timeliness of response by a targeted recipient of a campaign offer.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever

### BACKGROUND OF THE INVENTION

Mobile devices continue to be wildly popular amongst most people. In the not so distant past, mobile devices where confined to bulky cell phones, pagers, and personal digital assistants (PDAs) utilized primarily for business purposes. Advances in technology and reductions in cost created much smaller and affordable devices, such that nowadays most everyone owns at least one mobile device. For instance, mobile phones, music players, and global positioning system (GPS) devices, gaming systems, and electronic book readers are increasingly pervasive. Furthermore, smart phones and other hybrid devices are becoming very popular since they provide a combination of functionality in a single device.

Modern cellular phones typically provide a user with a number of features in addition to providing voice communication. These cellular phones are typically referred to as smart phones. Modern smart phones include sophisticated processing systems that provide a user with a number of software applications. Smart phones also include the capability of accessing the internet through connections established between those phones and nearby towers. Access to the internet allows a smart phone to provide a user with typical internet usage applications such as email and web-browsing.

Marketing and more specifically advertising has changed over time with technology. At one time, television, radio, and mail were the primary means for advertising. Accordingly, advertising was accomplished by way of commercials and direct mailings. With the advent of the Internet, advertisers were afforded additional dissemination mechanisms including e-mail and search. Consequently, advertisements are now also provided in the form of or within e-mail, embedded with Web pages, and proximate to or as search results, among other things.

SMS traffic, in the U.S. in particular, has seen widespread popularity. In reaction to the wide adoption of SMS, advertisers have begun adapting the platform for marketing purposes. The one-to-one nature of advertising on a personal wireless device, as well as the instant nature of SMS messages, makes for an attractive marketing method. However, due in large part to the opt-in nature of SMS marketing, the process of promoting a mobile campaign to generate exposure still requires considerable resources. Often, advertisements are distributed widely with a mere hope that a potential customer will receive the advertisement, and are not often used with qualified advertising leads.

The proliferation of mobile devices now provides advertisers with yet another way to reach potential customers. Further yet, advertisers are now seeking to exploit location information enabled by many mobile devices. Such functionality is often referred to as a location-based service (LBS) or alternatively location-based advertising (LBA).

Location-based services supply information as a function of the geographical position of a mobile device. One or more location mechanisms can be utilized by such services including GPS, triangulation, and local proximity technologies such as Bluetooth, infrared, wireless local area network (WLAN), and radio frequency identification (RFID), among other things. Applications can then utilize the determined location to aid navigation or focus search results.

These systems can determine the smart phone's location with a relatively high degree of accuracy. The combination of locating capabilities and internet access can allow the smart phone to provide a user with applications that can inform the user about various places in close proximity to the user. Marketers desire to make information about their business available to these applications so that the user can receive marketing messages when that user is within close proximity to that business.

Moreover and as previously mentioned, advertisements or the like can be transmitted to users based on their location as determined via their mobile device. For example, when a mobile phone is determined to be within a specified distance of a restaurant, a text message can be sent to the user including a promotional code associated with some discount, such as 10% off a meal or a free appetizer with the purchase of two entrees.

Other methods of delivering advertisements to mobile devices include the following. U.S. patent application Ser. No. 09/907,629 by Blom discloses a method involving an advertisement broker who obtains advertisements from advertisers and provides those advertisements to mobile users. But an advertisement is only provided to mobile users whose positions lie within a location associated with that advertisement, and the advertisement is sent to mobile users via email, which may not be supported by some mobile devices. Moreover, such location based advertisements do not provide any indication of a mobile user's likes, dislikes, selection criteria, loyalty preferences and other indicia needed to generate a targeted advertisement, offer or incentive.

U.S. patent application Ser. No. 09/907,899 by Gledje discloses a method whereby a service provider delivers advertisements to mobile users who are located in zones associated with those advertisements, who satisfy various demographic criteria, and who have subscribed to an advertising service. But many countries have privacy regulations that forbid provision of such location and demographic information to service providers. Further, location and subscriber-based approaches are not appropriate for some types of advertising.

However a problem with such systems is that there is no ability to determine what the user or consumer may be doing at the time that they are in proximity to a particular advertiser nor is there knowledge as to whether the user is currently engaging in purchasing or doing other things which would render him likely to be in a buying mode. Moreover while an application could determine whether a mobile communication device is within a specified distance from a restaurant or a clothing store there would be no additional information to indicate whether the user having the mobile device was desirous of eating, purchasing clothes or taking any other action. Thus providing a customized offer or reward to such a user would most likely not have any immediate or positive result and could actually have a negative result by cluttering up the mobile device with unwanted messages.

It is also a drawback in the prior art that location-based marketing as a function of the geographical position of the mobile device does not reward loyalty by having a user or customer go to locations they have frequented before and have demonstrated a loyalty to. Furthermore, it does not provide for a complementary marketing effort to engage the user and maximize the possibility of the consumer actually being enticed to purchase an item or frequent a location as a result of the delivery of a message or incentive.

It is yet a further drawback in the prior art that a particular user of a mobile device may not have an appropriate application to permit the sending of a location-based offer or may not, want to have their device cluttered with a relevant offers. Moreover the user of a mobile device may not want to activate the location determinant aspect of the device, thus preventing the generation of a location-based offer.

Thus it would be advantageous to correlate both the location of a mobile device, the user of that device and the actions that the user is currently taking in order to develop a higher probability that any messaging of an incentive or reward would be effectively employed to engage the user.

It would be additionally advantageous to employ a correlated variable factor matrix to generate a targeted incentive in response to the logging in by a mobile user to a loyalty kiosk whose location and merchant relationship is known, thus permitting the generation of an incentive which has a higher probability that any messaging of the incentive or reward would be effectively employed to engage the user.

The instant invention among other aspects fulfills the above needs and permits the creation and use of a variable factor correlation matrix in order to permit the maximization of marketing efforts particularly in the area of loyalty-based rewards and incentives.

### SUMMARY OF THE INVENTION

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to variable matrix based mobile marketing wherein one of the variables may be location based upon real-time inputted data at the loyalty kiosk, another variable may be the proximate relationship between the location and another loyalty related merchant and yet another variable may be the complementary nature of the business of the first merchant and the second merchant. Thus it is a part of the invention to generate and employ variable matrix factors that include more information than simple geographic location. Among other things that can be taken into account are a user profile, user preferences/settings, advertiser preferences/settings, and/or extrinsic data. Advertisements can thus be correlated with and delivered to users or consumers with much specificity. Consequently, consumers receive advertisements that are more relevant and advertisers can better target consumers.

In accordance with one aspect of the disclosure, a mobile marketing system is positioned between a plurality of consumers and advertisers to facilitate provisioning of advertisements including promotional offers, coupons, or the like. Both consumers and advertisers can register with the system and provide pertinent information including, without limitation, profiles, preferences, and/or settings. Furthermore, facilities can be provided to aid advertisers in campaign generation and management. Based on consumer and advertiser information as well as otherwise acquired context information, advertisements can be matched with consumers and subsequently delivered thereto.

In accordance with another aspect of the invention, the unique position of loyalty kiosks within the system enables geo-fencing information and transactional information to be correlated and employed to maximize advertisement matching and also permit promotional offer redemption to be leveraged to aid subsequent advertisement correlation.

According to another disclosed aspect, at least a portion of the mobile marketing system can be provided as a mobile device application. For example, if the mobile device corresponds to a phone, the phone can include a plurality of interfaces to acquire consumer information as well as a means for pushing advertisements to users, among other things.

Yet another aspect of the present invention provides a personalized consumer marketing system and more specifically a geo-fencing marketing system and method for the acquisition of personal data via location specific data entry and associated non-transitory computer-readable storage media having computer-executable instructions embodied thereon situated within a business environment to secure customer data for use in SMS/text location specific marketing campaigns and to permit automation of personalized marketing, benefits and incentives to customers as a function of specific customer preference data, historical activities and variable factor matrix determinations.

In another aspect of the present system and invention, the system and method further provide auto-feedback updating to modify the variable factor matrix and data/status updates of the market campaign based on business designated triggers.

The present invention further relates to the cross referencing of consumer loyalty related incentives among proximately related merchants based upon personalized consumer preferences, location based determinants and matrix complement factors to automatically deliver to a consumer a personalized offer, incentive, benefit or data relating thereto in order to solicit the consumer's immediate participation in the offer, incentive or benefit by visiting the designated location of a proximately related merchant.

The invention further relates to the creation of one or more location based offers or rewards in which a customer, upon checking into the merchant specific kiosk, will thereafter receive a targeted incentive message via SMS or there messaging methodology based upon the known location of the kiosk. The incentive message will provide the customer with a proximately located merchant who is able to provide a complementary incentive and qualifies the redemption of that complementary incentive with certain temporal requirements, such as redemption within the next hour.

The invention further relates to the aggregation of data from multiple input sources to generate automated personalized marketing campaigns and functions via one or more non-transitory computer-readable storage media having computer-executable instructions embodied thereon, wherein when executed by at least one processor, the computer-executable instructions cause the at least one processor to acquire data relative to a customer to permit the generation of one or more loyalty/reward messages to the customer based on the determining factors in a variable factor matrix, factors of which are capable of feedback updating both with regard to individual mobile user and, to a group of loyalty-based mobile users.

To the accomplishment of the foregoing and related ends, certain illustrative aspects of the claimed subject matter are described herein in connection with the following description and the annexed drawings. These aspects are indicative of various ways in which, the subject matter may be practiced, all of which are intended to be within the scope of the claimed subject matter. Other advantages and novel features may become apparent from the following detailed description when considered in conjunction with the drawings and the features, functions, and advantages that have been discussed can be achieved independently in various embodiments or may be combined in yet other embodiments further details of which can be seen with reference to the following description and drawings.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

### BRIEF DESCRIPTION OF THE DRAWINGS

FIG. 1 is an illustrative embodiment of an interactive marketing system employing a geo-fencing system in accordance with the method, system and programs of the present invention.

FIG. 2 is a block diagram that illustrates a preferred embodiment of a geo-fencing marketing system for obtaining geo-fencing information and related data and thereafter processing and delivering customer specific incentives and actions in accordance with the method, system and programs of the present invention.

FIG. 3 is a block diagram illustrating a system and method for individualizing and delivering incentive messages and for otherwise employing a geo-fencing marketing system for securing and processing customer data and actions and delivering customer specific incentives in accordance with the method, system and programs of the present invention.

FIG. 4 is a high level flowchart illustrating a system and method in accordance with an aspect of the method, system and programs of the present invention.

### DETAILED DESCRIPTION OF A PREFERRED EMBODIMENT

Some embodiments described herein involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The above examples are exemplary only, and thus are not intended to limit in any way the definition and/or meaning of the term processor.

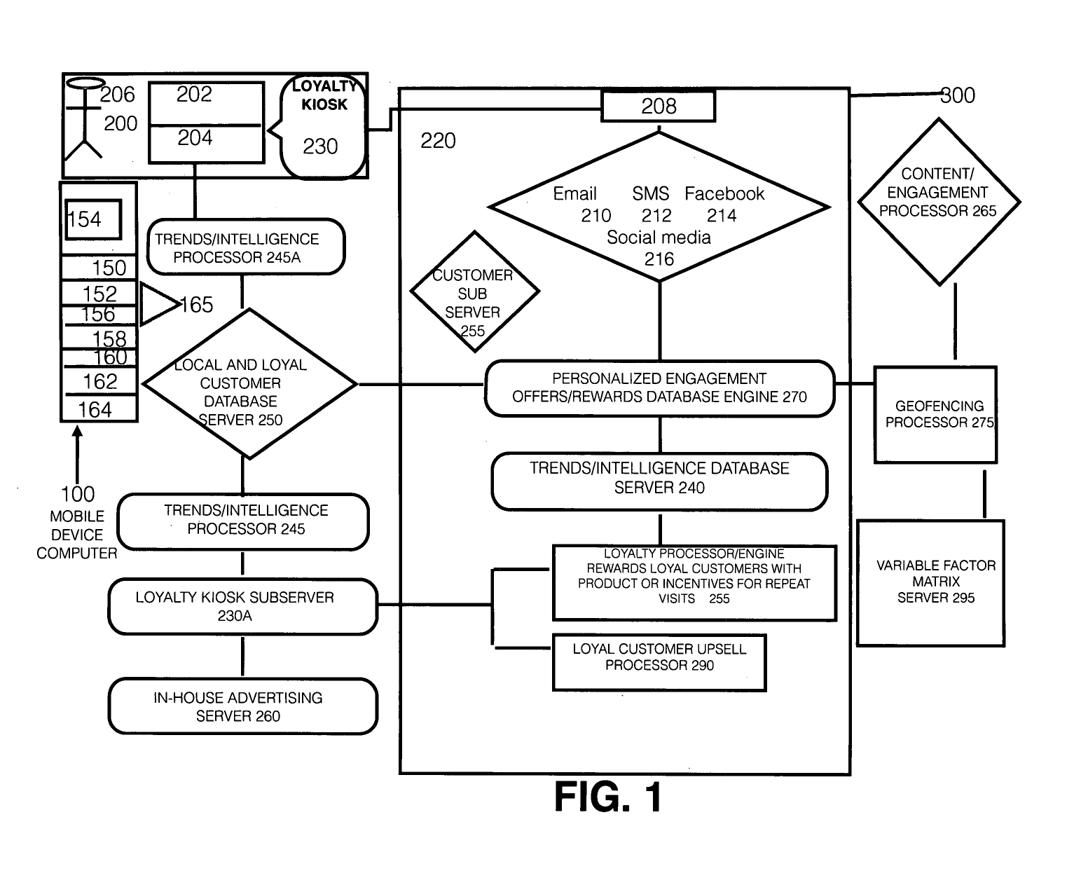

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. For clarity of explanation, the illustrative system embodiment is presented as comprising individual functional blocks (including functional blocks labeled as a “processor”, “server” or “engine”). The functions these blocks represent may be provided through the use of either shared or dedicated hardware, including, but not limited to, hardware capable of executing software. For example the functions of one or more processors presented in FIGS. 1-4 may be provided by a single shared processor or multiple processors. Use of the terms “processor” or “server” or “engine” should not be construed to refer exclusively to hardware capable of executing software.

In one or more exemplary embodiments provided herein, the programmed instructions may be generated as a group of co-operative software modules, each having its dedicated functions. The descriptions of such modules will allow one of ordinary skill in the art to readily appreciate the programming instructions required for implementing the disclosed processes herein. However, the programmed instructions themselves can be implemented in wide array of ways, depending, for example, on the operating system and software applications/environments selected, as well as on designer preference.

Such electronic or computing devices also typically include a memory coupled to the processor. The memory may include one or more tangible, non-transitory, computer readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory.

The terms “processor” or “server” or “engine” as used herein are broadly defined as one or more processing units of any type for performing all arithmetic and logical operations and for decoding and executing all instructions related to facilitating an execution of the various methods of the present invention. Additionally, the term “memory” as used herein is broadly defined as encompassing all storage space in the form of computer readable mediums of any type.

The methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, such as a firmware, physical and virtual storage, CD-ROMs, DVDs and another digital source such as a network or the Internet, as well as yet to be developed digital means, with the sole exception being a transitory, propagating signal.

In the one form of the present invention, the system comprises a processor and a memory storing data and information about the customer and/or the merchant and/or the campaign specifics and the data related to each of those along with a network communication system storing customer information that is related to each merchant with whom the customer interacts. The processor and memory store instructions operable with the processor for executing an interaction among the distinct modules to facilitate a communication between the customer and the campaign via SMS or other messaging protocol and generation of appropriate rewards and incentives for defined actions.

The instructions are executed to permit the communication and to obtain at least some information back from the customer in order to provide feedback both as to the actions of the customer and to maximize the effectiveness of the messaging. The information, that is received from a client is employed to update the campaign profile relative to that customer in order to individualize the messages as well as generating campaign data to permit the merchant to better manage the campaign and influence future campaigns and the language and motivational parameters of the current campaign.

Illustrated in FIG. 1 is one implementation of a computing device 100 such as any computing device described herein. Computing device 100 can include a central communication bus 150 that communicates with each of the components included in the computing device 100. These components can include: an input/output (I/O) control 152; a display device 154; a network interface 156; a storage repository 158; a main processor 160; cache 162; and memory 164. The main processor 160 can include elements such as one or more I/O ports, or a memory port 165.

Further referring to FIG. 1, and in more detail, in some implementations the computing device 100 can be any computing device 100 having a processor 160. The computing device 100 can be a mobile device such as a laptop, netbook, smart phone, electronic reader, cell phone, personal digital assistant, tablet computer or any other hand-held computing device comprising a processor 160. In some implementations, the computing device 100 can be any hand-held mobile device able to carry out the methods and systems described herein. In some implementations, the computing device 100 can be a computer, a client computer, a server, or any other machine comprising a processor 160 able to execute computer readable instructions. The computing device 100, in some implementations, can be referred to as a computer, a computing machine, a machine, a device, a mobile device, or a mobile device.

The processor 160 included in the computing device 100 can be referred to as a central processing unit (CPU) or as a main processor. In some implementations, the processor 160 can include a single processing core, while in some implementations the processor 160 can include multiple processing cores. When the processor 160 includes multiple processing cores, the cores can execute in parallel and can access a shared Memory location or individual memory locations assigned to particular cores. In some implementations, the computing device 100 can include multiple processors 160. When the processor 160 includes multiple processing cores or multiple processors, the processors can execute a single instruction simultaneously on multiple pieces of data (SIMD), or in some implementations can execute multiple instructions simultaneously on multiple pieces of data (MIMD).

In one implementation, the processor(s) 160 can be any processor. In some implementations, the processor(s) 160 can be any combination of a microprocessor, a microcontroller, programmable logic gates, or any other processor. The processor 160, in some implementations, can further comprise a graphics processing unit (GPU) which can include any combination of hardware and processor-executable instructions for processing graphics data and graphics commands. In some implementations, the processor 160 can further comprise a graphics engine or any other processing engine.

Referring again to FIG. 1 there shown a customer 200 at a point of transaction device 202 having a user interface 204 within a network communication system 220. The point of transaction device 202 is ideally located within a merchant establishment 206. A telecommunications system 208 is interconnected to a series of communications means such as e-mail 210, SMS 212, Facebook pages 214 and other social media/telecom modulated systems 216.

A loyalty kiosk 230 is advantageously disposed in proximity to the point of transaction device 202 in order to permit the customer 200 to see the various campaign information which is packaged and displayed appropriately in the loyalty kiosk 230 of the particular merchant establishment 206. Thus, for example, if a customer 200 has gone into a merchant establishment 206 where they generally go to purchase clothes, appropriate campaign information will be displayed at the loyalty kiosk 230 so that the customer 200 will see it and will be prompted to enter their telephone number and interact with the loyalty kiosk 230.

As a further part of the system, the loyalty kiosk 230 may also request additional customer data from the customer 200 at the same time that it is displaying the campaign information to that customer. Thus, by way of example, the loyalty kiosk 230 may ask for an update of the customer 200 E-mail address or suggest that an incentive or other discount maybe available which is related to the customer 200 current purchase.

At the time that the customer 200 enters their telephone number and customer data, the system 220 will enter the telephone number and related data into both a database 250 of local and loyal customers and provide an individual database of personalized engagement offers and rewards through a personalized offer/rewards engine 270 which is designed for the individual customer 200. The personalized offer/rewards engine 270 maybe a part of the main database 250 or maybe a register maintained separately from the main database 250.

Once the customer 200 enters their telephone number, it permits a series of actions to be implemented by the system 220. The system 220 engages the geo-fencing processor 275 to initiate the determination of the location of the accessed loyalty kiosk 230 and access the variable factor matrix server 295. The system 220 also engages a main trends/intelligence processor 240 to determine when the customer 200 had last been at the merchant establishment 206, what their prior purchase had been and to otherwise permit the aggregation of data on that customer 200.

As a further part of the system, a core database server 300 structure aggregates data from multiple input sources which relate to the customer 200 who has entered their telephone number and provides that information to the content engagement processor 265 which operates in conjunction with the geo-fencing processor 275. When the customer 200 checks into any loyalty kiosk 230 which is associated with a merchant establishment that forms part of the multi-merchant loyalty marketing system it provides precise data on a real-time basis as to the location of the customer 200 without the customer having to enable location services on their phone, run a separate application or take other action independent from the mere logging onto the loyalty kiosk 230.

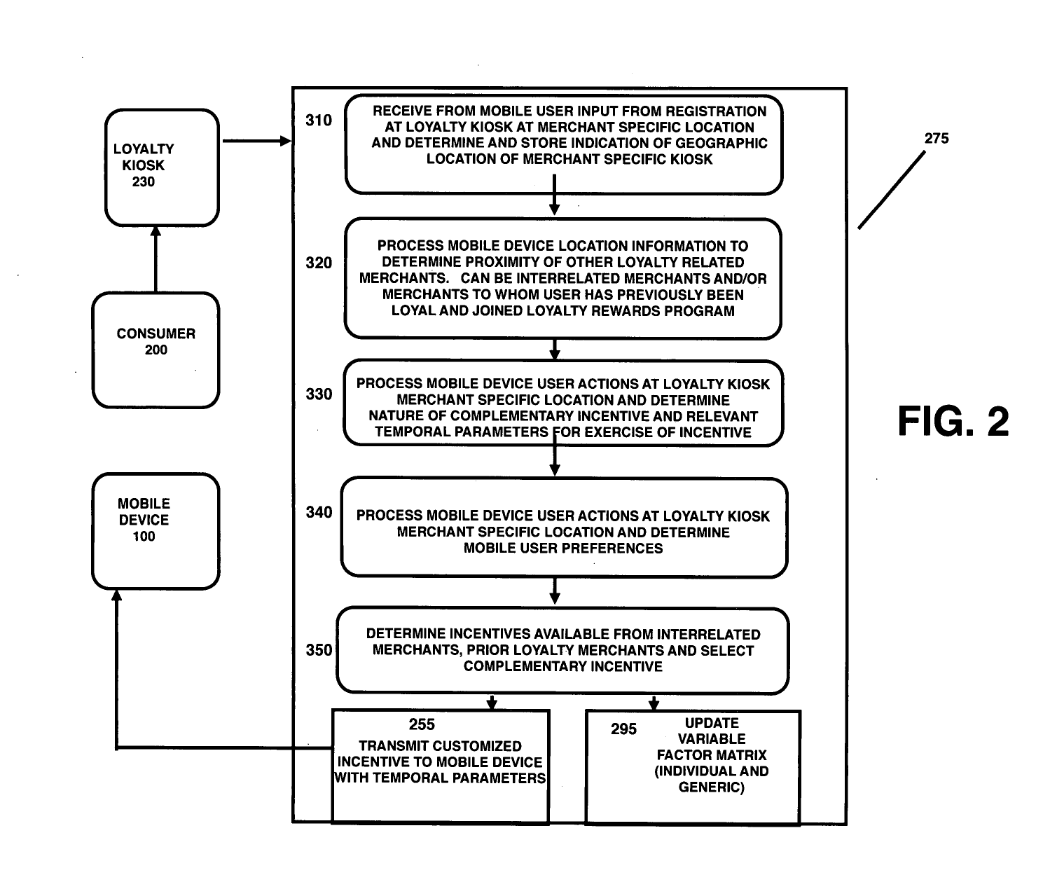

Referring to FIG. 1 and FIG. 2, once the customer 200 checks into a loyalty kiosk 230 the geo-fencing processor 275 immediately checks to see if the customer 200 is subscribed or registered with any merchants in close proximity to the loyalty kiosk 230. Once it has made the determination of the existence of one or more merchants in close proximity to the loyalty kiosk 230, it engages a variable factor matrix server 295 that determines, among other things, whether any of the merchants in close proximity to the loyalty kiosk 230 are complementary businesses to that business which houses the loyalty kiosk 230.

The variable factor matrix server 295 maybe employ a multiplicity of factors some of which may have been generated by the customer 200, others of which may be generated by one or more merchants who are participants in the loyalty marketing system and still others of which are a function of marketing determinations as to what constitutes a complementary incentive to the products or services which are offered by the merchant housing the loyalty kiosk 230. The variable factor matrix server 295 may also determine to provide loyal customer 200 with products or incentives for repeat visits to the merchant establishment where the loyalty kiosk 230 is situated as well as provide the customer 200 with the possibility of an upsell or additional benefit at the merchant establishment where they have signed in.

The variable factor matrix server 295 may engage a loyalty processor engine 255 to provide the customer 200 who has just logged in at loyalty kiosk 230 with a product or incentive for a repeat visit or may engage an upsell processor 290 to provide the customer 200 with one or more incentives to acquire additional merchandise at the merchant that is currently being visited. Concurrently, the variable matrix server 295 will engage the geo-fencing processor 275 to deliver a customized offer to the customer 200 to seek to entice that customer to visit a proximately located merchant. The customized offer to the customer 200 may be in the form of an incentive which provides for a reduced price for a complementary product or a notification that a series of special offers are being provided if the customer 200 goes to the complimentary business location within a certain period of time.

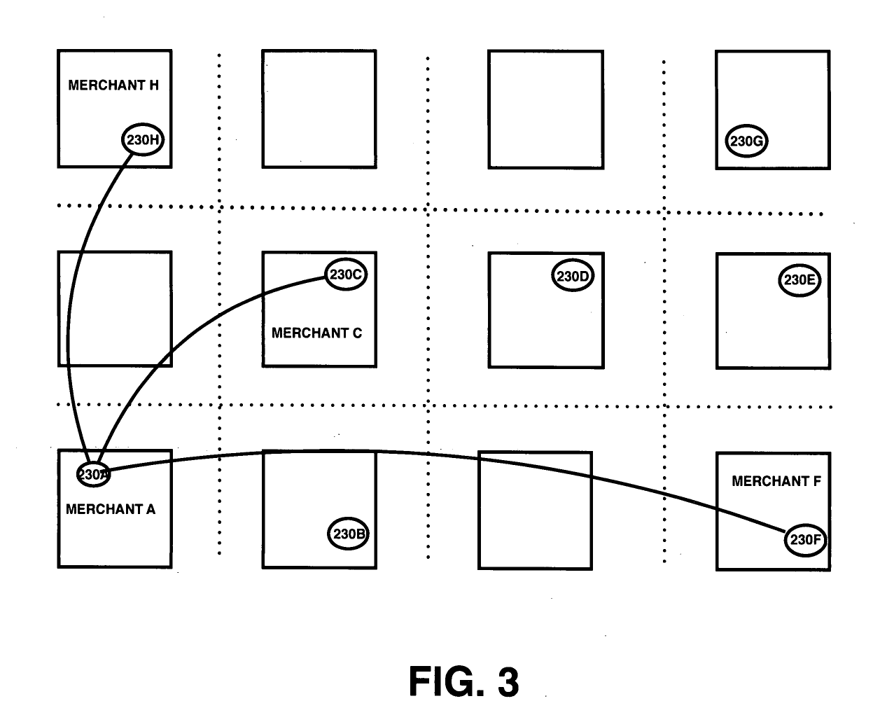

Referring to FIG. 1, in conjunction with FIG. 2 and FIG. 3, the variable factor matrix server 295 may employ, among other factors, the distance between the loyalty kiosk 230 where the customer 200 has initially registered and the location of other loyalty merchant participant loyalty kiosks (230 B-H), preferences that have been indicated by the customer 200, specific offers and incentives that are being provided by other loyalty merchant participants in the general area of the loyalty kiosk 230. The variable factor matrix server 295 may also determine whether the loyalty merchant where the loyalty kiosk 230 is situated has incentives that would permit the customer 200 to enjoy further benefits from that specific merchant.

Other factors that may be employed by the variable factor matrix server 295 may be comprised of the following illustrative loyalty programs:
a. A loyalty program in which points are given for every dollar spent at any of a plurality of stores having diverse retail practices, such as a clothing chain, a hardware chain, and a restaurant chain. A customer who uses the loyalty kiosk 230 and participates in this program accumulates points at any of the stores and may exchange the accumulated points for goods at any of the stores. For example, the customer may make a series of purchases at the hardware chain over a period of time and may subsequently redeem the points for dinner at a restaurant that forms part of the restaurant chain. This is an example of a purely monetary loyalty program that operates by proximately located individual chains determining how to allocate point values among themselves to accommodate their respective benefits of participating in the program. This is also an example where different money-point correlation rates may be appropriate to account for differences in retail practices among the merchants.
b. A loyalty program in which a proximately located pizza chain and a video-rental chain cooperate. They advertise collectively that anyone who buys three pizzas at the pizza chain may receive a free video rental at the video-rental chain and anyone who rents fifteen videos at the video-rental chain is entitled to a free pizza at the pizza chain. Customers logging in to loyalty kiosk 230 A at the pizza parlor or loyalty kiosk 230 B located at the video store have their purchases of pizzas and rentals of videos recorded so that the reward may be issued when the criteria have been fulfilled. Such rewards may be given automatically at the point of sale when the customer uses his card. This is an example of a frequency-based reward system that uses the system to integrate separate organizations into the plan in a cooperative way and to permit the customer 230 to be incented, via the geo-fencing processor 275 in conjunction with the variable factor matrix server 295, to go to the proximately located video store after picking up a pizza by reminding them of the benefit and providing an additional incentive for an immediate visit.
c. A loyalty program in which a movie-theater chain, a bookstore chain, and a music-store chain that are otherwise independent from one another cooperate. They offer a program in which, in any monthly period, a $25.00 purchase at each of two of the chains entitles the customer to a $5.00 rebate towards a purchase at the third chain. The log in at a loyalty kiosk 230 and purchase by customer 200 having registered in one or more of the programs are recorded whenever they visit any of the three chains and issue the appropriate reward when the conditions are met. This example combines aspects of recency-based and monetary-based loyalty systems that use the aggregator to permit separate organizations to cooperate to their mutual benefit. This also permits the variable factor matix server 295 to determine if a customer 200 has not visited a proximately located merchant and send an additional incentive to entice them to go to that additional merchant immediately in order to benefit from the incentive.

The systems described herein are suitable for accommodating a large variety of different types of loyalty programs. Individual programs may be specific to an individual store or organization or may span across multiple otherwise unrelated organizations as part of a more comprehensive loyalty system. In one aspect, individual customers may participate in multiple loyalty programs that are managed as independent programs by the system 220 and the core database server 300 structure so that it serves as an aggregator. Points maintained for the different programs are identified and distinguished by different point types. In this way, the customer 200 may be able to use a single loyalty kiosk 230 log in for participation in all of their loyalty programs.

For each of the loyalty programs, rewards may be accumulated in at least three ways. First, rewards may be based on recency, or other temporal criteria, in which a reward is triggered either by completing a transaction within a specified time interval or by completing a specified number of transactions within a given time interval. Second, rewards may be based on frequency, in which a reward is triggered by completing a specified number of transactions. Third, rewards may be monetarily based so that a reward is triggered when a specified total transaction amount is reached. Such triggers may be specified for individual transactions or may be specified for accumulated transaction amounts over multiple transactions.

In addition, reward triggers may be conditional. Examples of conditional triggers include a requirement that points be accumulated only for transaction above a certain amount, and perhaps that points be accumulated more generally at different rates for transactions of different sizes. Other conditional triggers may be associated with time constraints so that points may only be accumulated only after a specified date, only before a specified date, only an certain days of the week, only during certain holiday periods, etc. Accumulation of points may also be conditionally restricted to certain tender types and to transactions where no reward is applied.

Although accumulation of rewards is generally tracked in terms of points and rewards are generally based on points, the instant invention permits the augmentation of such systems to permit additional loyalty factors to provide incentives. Thus, just by logging into a loyalty kiosk 230, a customer 200 has demonstrated their loyalty to both the current merchant and the overall aggregate multi-merchant loyalty system. Such points will generally be correlated with aspects of a transaction, and may be set to expire after a certain time period or at a predetermined time. Thus, for a recency loyalty system, points will generally be set to expire within the time period required for completion of the transactions. For a frequency loyalty system, points will usually be integers corresponding to the number of transactions completed. For a monetary loyalty system, points will be correlated with the dollar amount of the transaction. The correlation rates may differ for different issuers, even within the same loyalty program, requiring use of the settlement functions described below. Points may generally be structured to expire periodically or after a specified period of inactivity to prevent excess accumulation by individual customers. Furthermore, point totals for individuals may be conditioned to reset when awards are given, to reset on a cyclical basis (e.g., monthly or annually), to continue to accumulate (rewards given for different levels reached), or to be permanently eliminated upon issuance of a reward (such as for a one-time reward).

In certain embodiments, points may be accumulated collectively by multiple customers. For example, each member of a family may have a separate card that identifies them individually, but points are accumulated into an account for the family as a whole. In other embodiments, points may be transferred among customers.

Referring again to FIG. 2 and FIG. 3, there is shown an illustrative embodiment of the variable factor matrix server 295 and geo-fencing processor 275 in which the consumer 200 registers and signs in at the loyalty kiosk 230. The login information is received from the mobile user (customer 200) input from the registration at the loyalty kiosk 230 at the merchant specific location. The geo fencing processor 275 determines the type of store that the customer 200 is frequenting and by knowing the location of the loyalty kiosk 230, the geo-fencing processor 275 knows the geographic location of that store.

The geo-fencing processor 275 then determines the proximity of other loyalty related merchants to the loyalty kiosk 230. The geo fencing processor 275 then employs the variable factor matrix server 295 to determine whether any of the other loyalty related merchants have incentives or rewards that are complementary to the product or service sold by the first store where the customer 200 has logged into the loyalty kiosk 230 and will also determine whether there are interrelated incentives between that store and other proximately located stores and whether the customer 200 has registered with those proximately located stores.

The geo-fencing processor 275 may also determine that the customer 200 has not registered with certain merchants who have complementary incentives and may offer to the customer 200 those incentives conditioned upon the customer 200 registering with those merchants. The geo-fencing processor 275 may also determine that certain temporal parameters should be employed in connection with the incentives and condition those incentives upon exercise of the incentive by the customer 200 with a specified period of time.

The geo-fencing processor 275 they also ascertain the relative loyalty reward completion for various merchants in close proximity to the loyalty kiosk 230 that has been accessed and provide multiple incentives based upon the completion of a reward program for one or more merchants. This information regarding the completion of a reward program will further incent a customer 200 to undertake the reward fulfilling action in order to complete the reward program.

Geo-fencing processor 275 may also ascertain the specific customer 200 preferences in determining the customized incentive that it will send to the mobile device 100. Thus, by way of example, if the customer 200 has indicated a preference for incentives related to electronics, the geo-fencing processor 275 may provide an incentive from a proximately located electronic store and concurrently provide a further incentive from a proximately located store that provides complementary products or services.

Geo-fencing processor 275 may also determine through the variable factor matrix server 295 that interrelated merchants have a series of incentives that comport with the customer 200 preferences and also are complementary to the current activity being performed by customer 200 at the merchant location of the loyalty kiosk 230. Thus the geo-fencing processor 275 may send multiple incentives on a proximity basis from one or more of the interrelated merchants.

Following the transmission of the customized incentive to the mobile device 100 of the consumer 200, the geo-fencing processor 275 in conjunction with the variable factor matrix server 295 will update the individual and generic information contained in the variable factor matrix server 295 so as to indicate the action and login by the customer 200 to the loyalty kiosk 230 and any subsequent action taken by the customer 200 in response to the customize incentive. By way of example, if the customer 200 responds to the customized incentive the individual file for that customer is updated to show the positive response and the generic variable factor matrix is also updated to show that the response was positive. Alternatively, if the customer 200 does not respond that is also used to update the variable factor matrix server 295 data.

Accordingly, various embodiments of the present invention directed to a system and method for creating a loyalty kiosk 230 reward system are provided. A system may receive information identifying a user in proximity to a loyalty kiosk 230 location and then provide the user notification of available rewards for that particular user at the loyalty kiosk 230 location based on a rewards account associated with that particular user. The information may be sent to the system by a system that receives information at a location proximate to a loyalty kiosk 230 location that is used to identify a user associated with a rewards account and transmits the information to a rewards system, whereby the rewards system may use the information to identify reward information available to the user at the loyalty kiosk 230 location and send a notification to the user related to the rewards for that user at a loyalty kiosk 230 location to which the user is proximate.

The user may provide identification at the loyalty kiosk 230 to facilitate notification of particular rewards, and the rewards may be provided to the user at the loyalty kiosk 230. The user may be notified in many potential ways. For example, and without limitation, the user may be notified of rewards via a text message to the user's cellular telephone, a voice mail message, an e-mail, or a web page.

The method of notification may optionally be associated with the user's reward account. The identification that the user may provide at the loyalty kiosk 230 may include biometric data or data from a financial card read with a card reader or the user identification may be a username and password combination that the user may enter at the loyalty kiosk 230 location.

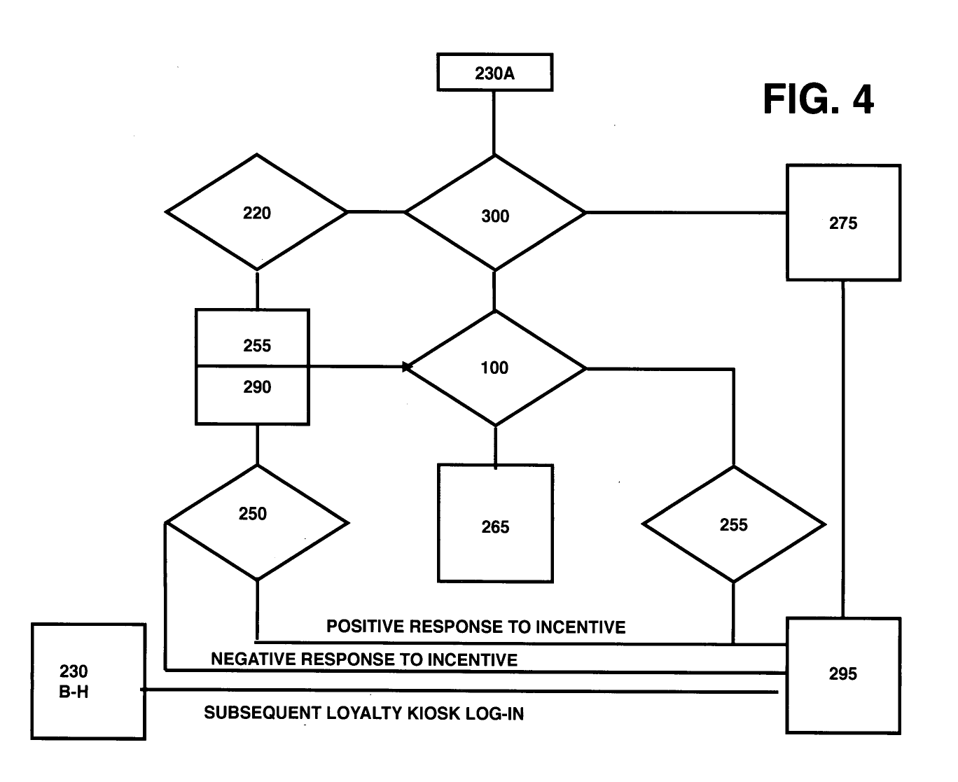

Referring to FIG. 3 and FIG. 4, in accordance with an embodiment of the present invention there is shown a proximity system in which a registration or login at a first loyalty kiosk 230A is sent to module 310 which then generates, via modules 320-350, based upon the determination by the geo-fencing processor 275 in conjunction with the variable factor matrix server 295, a series of alternative personalized rewards or incentives associated with, by way of example, the merchants having loyalty kiosks 230 C, 230 F and 230 H. Those personalized rewards or incentives may have temporal aspects associated with them such as: “Come to merchant F within the next hour and receive 20% off all goods to the store.”

Alternatively, the personalized reward or incentive associated with merchant H may be complementary to the activities being undertaken at loyalty kiosk 230 A and be time related. Thus, by way of example, module 350 may determine an incentive and have it transmitted via a loyalty processor engine 255. The incentive may say: “It's almost lunchtime. After you're done clothes shopping why don't you come today to merchant H for lunch and relax with a free glass of wine with any lunch over eight dollars”. Such an incentive has both time aspect and is reflective of the activity which the geo-fencing processor 275 intuits by virtue of the location of the loyalty kiosk 230 A which is situated at a clothing store.

Based upon the response by the customer 200 to the personalized reward or incentive, the customer database server 250 is updated and the variable factor matrix server 295 is provided with the input from the customer database server 250 in order to update both the generic variable factor matrix and the customer specific variable factor matrix maintained by the very whole factor matrix server 295. Additionally, if there is no action taken by the customer 200 in response to the personalize reward or incentive but the customer 200 then logs into another loyalty kiosk which is not subject of the personalize reward or incentive that information is immediately forwarded to the geo fencing processor 275 and variable factor matrix server 295 to permit them to update the profile of the customer 200 by taking into account the actual actions taken following the delivery of the personalized reward or incentive.

Although the present disclosure has been described with reference to preferred embodiments, persons skilled in the art will, recognize that changes may be made in form and detail without departing from the spirit and scope of the disclosure. For example, it is recognized that multiple embodiments of rewards or incentives or other communication methodologies may be suitable for use with the system and method of the present disclosure. Furthermore, although the present disclosure relates to loyalty kiosks, the benefits and incentives are not limited to loyalty kiosks, but extends to loyalty input systems whereby a customer demonstrates their loyalty to a merchant or series of merchants and is receives either individual or aggregate incentives. The system may also be employed to elicit reward based activities other than from the purchase of goods.

What is claimed is:

1. An automated geo-fending loyalty marketing system comprising:
a. a loyalty kiosk situated at a merchant establishment that communicates with a loyalty recipient customer over a network interface with a loyalty rewards data base upon activation by, said loyalty recipient customer;
b. a processor having a memory for storing profile and loyalty activity data for at least one loyalty recipient customer, said processor administering a plurality of loyalty awards benefit programs to which the at least one loyalty recipient customer is enrolled;
c. an award benefits administration engine having different award benefits rules applicable to each of a plurality of merchants to administer a plurality of award benefits programs sponsored by said plurality of merchants and generate personalized offers and awards to the at least one loyalty recipient customer;
d. loyalty kiosk activation means through a customer unique identifier;
e. acquiring means to secure and transmit a the location of the activated loyalty kiosk;
f. a geo-fencing processor capable of determining the loyalty recipient customer's loyalty kiosk activation;
g. a variable factor matrix server associated with the geo-fencing processor capable of selecting an appropriate personalized advertisement, offer or reward based upon merchant and customer advertisement, offer or reward benefit criteria and proximity of the merchant to the activated loyalty kiosk;
h. a rewards engine to deliver, to a customer supplied address to said processor and transmit data to the customer at the supplied address at a location remote from the loyalty kiosk;
i. a trends/intelligence database server capable of evaluating the loyalty recipient customer's advertisement, offer or reward, the response thereto and aggregating the responses of loyalty recipient customers to revise and update advertisements, offers and rewards for transmission upon subsequent loyalty kiosk activations.

2. An automated geo-fencing marketing system of claim 1 wherein the plurality of award benefits programs sponsored by said plurality of merchants are geographically correlated to provide the loyalty recipient customers with a proximately determined incentive.

3. An automated marketing system of claim 1 wherein a proximately located award benefit is provided to the loyalty recipient customer upon activation of the loyalty kiosk by the loyalty recipient customer.

4. An automated marketing system of claim 3 wherein a second award benefit is determined by the variable factor matrix server and is provided to the loyalty recipient customer through the customer supplied address at a location remote from the loyalty kiosk.

5. An automated marketing system of claim 1, additionally comprising means to deliver a geographically determined personalized message at the loyalty kiosk relating to proximately determined incentives for the loyalty recipient customer's account.

6. An automated marketing system of claim 1, comprising means to deliver a personalized message to the customer supplied address at a location remote from the loyalty kiosk relating to a temporally and geographically related reward available to the loyalty recipient customer.

7. An automated marketing system of claim 1, wherein the personalized message to the customer supplied address is delivered to a mobile communication device.

8. An automated geo-fencing loyalty marketing method implemented by a loyalty recipient customer comprising:
a. activating a loyalty kiosk situated at a merchant establishment by the loyalty recipient customer to communicate over a network interface with a loyalty rewards data base upon activation by said loyalty recipient customer;
b. storing profile and loyalty activity data for at least one loyalty recipient customer, said processor administering a plurality of loyalty awards benefit programs to which the at least one loyalty recipient customer is enrolled;
c. activating an award benefits administration engine having different award benefits rules applicable to each of a plurality of merchants to administer a plurality of award benefits programs sponsored by said plurality of merchants and generate personalized offers and awards to the at least one loyalty recipient customer;
d. activating the loyalty kiosk through a customer unique identifier;
e. acquiring and transmitting the location of the activated loyalty kiosk to a geo-fencing processor;
f. validating the loyalty recipient customer's activation;
g. selecting a geo-fenced appropriate personalized advertisement, offer or reward based upon merchant and customer advertisement, offer or reward benefit criteria and proximity of the merchant to the activated loyalty kiosk;
h. a delivering to a customer supplied address, via a rewards engine, the geo-fenced personalized reward to the customer at the supplied address at a location remote from the loyalty kiosk; and,
i. evaluating, via a trends/intelligence database server, the loyalty recipient customer's advertisement, offer or reward, the response thereto and aggregating the responses of loyalty recipient customers to revise and update advertisements, offers and rewards for transmission upon subsequent loyalty kiosk activations.

9. The automated geo-fencing marketing method of claim 8 comprising correlating the plurality of award benefits programs sponsored by said plurality of merchants to provide each of the plurality of merchants with data relative to each of the loyalty recipient customers.

10. The automated geo-fencing marketing method of claim 9 wherein a award benefit is geographically correlated to provide the loyalty recipient customers with a proximately determined incentive upon activation of the loyalty kiosk by the loyalty recipient customer.

11. The automated geo-fencing marketing method of claim 10 wherein a second award benefit is determined by the variable factor matrix server and is provided to the loyalty recipient customer through the customer supplied address at a location remote from the loyalty kiosk.

12. The automated geo-fencing marketing method of claim 10 wherein a personalized message is delivered at the loyalty kiosk relating to the loyalty recipient customer's account.

13. The automated geo-fencing marketing method of claim 10 wherein a personalized message is delivered to the customer supplied address at a location remote from the loyalty kiosk relating to the loyalty recipient customer's account.

14. The automated geo-fencing marketing method of claim 8 additionally comprising delivering a geographically determined personalized message at the loyalty kiosk relating to proximately determined incentives for the loyalty recipient customer's account.

15. The automated geo-fencing marketing method of claim 8 additionally comprising delivering a personalized message to the customer supplied address at a location remote from the loyalty kiosk relating to a temporally and geographically related reward available to the loyalty recipient customer.

16. The automated geo-fencing marketing method of claim 8 additionally comprising delivering the personalized message to the customer supplied address is delivered to a mobile communication device.

17. The automated geo-fencing marketing method of claim 8 additionally comprising delivering the personalized message to provide an immediate sales proposal in pre-determined geographical proximity the activated loyalty kiosk wherein said personalized message is determined by a variable factor matrix.
